(19) United States
(12) Patent Application Publication
(10) Pub. No.: US 2026/0088523 A1
(43) Pub. Date: Mar. 26, 2026

(54) CONNECTION ELEMENT FOR ELECTRICALLY CONNECTING ELECTRONIC ELEMENTS

(71) Applicant: Robert Bosch GmbH, Stuttgart (DE)

(72) Inventors: Wolfram Kienle, Magstadt (DE); Ingo Fritsch, Wendlingen A.N. (DE); Marcus Sonner, Reutlingen (DE)

(21) Appl. No.: 19/110,945

(22) PCT Filed: Jul. 13, 2023
(86) PCT No.: PCT/EP2023/069427

§ 371 Date: Mar. 12, 2025

(30) Foreign Application Priority Data
Sep. 30, 2022 (DE) 10 2022 210 375.0

(51) Int. Cl. H01R 4/02; H01R 12/52

(52) U.S. Cl. CPC H01R 4/02; H01R 12/52

(57) ABSTRACT

The invention relates to a connection element (10) for electrically connecting electronic elements (11, 12), comprising a first connection region (1), which is designed for connection to a first electronic element (11), and a second connection region (2) which is designed for connection to a second electronic element (12), wherein each connection region (1, 2) is in the form of a sheet, wherein the first connection region (1) is in a first connection plane (21), and wherein the second connection region (2) is located at a distance from the first connection plane (21).

### BACKGROUND

The present invention relates to a connection element for electrically connecting electronic elements, an electronic assembly, and an inverter.

Electronic assemblies are known, for example in the case of inverters in which conductive elements are used for the transfer of electrical energy, in particular current. Sheets of a conductive material are often used as connectors between two elements. The connection of the sheet metal to the elements can occur, for example, by means of welding. Thermal and mechanical stresses on the electronic assembly can often lead to damage in the region of the electrical connections.

### SUMMARY

By contrast, the connection element according to the disclosure is characterized by the fact that a particularly high degree of robustness and longevity of an electrical connection of electronic elements can be provided, with a high electrical conductivity. In particular, thermal and mechanical stresses and deformations can be particularly well compensated for in order to avoid damage to the electrical connection. According to the present invention, this is achieved by a connection element for electrical connection of electronic elements, comprising a first connection region designed for connection to a first electronic element and a second connection region designed for connection to a second electronic element. Each of the two connection regions is designed in the form of a sheet. The first connection region lies in a first connection plane and the second connection region is located at a distance from the first connection plane.

In other words, a connection element is provided that comprises two separate connection regions, each of which can be connected to an electronic element, for example an electronic component, or to separate sub-regions of a single electronic component. The second connection region is located at a distance from a first connection plane in which the first connection region lies. Preferably, the two connection regions are thus located on different planes. Preferably, at least one deflection region is thus located between the two connection regions, which causes at least one change in the direction of the preferably entirely sheet-like connection element. This provides a mechanical flexibility of the connection element. In particular, this provides flexibility in a direction that is orthogonal to the first connection plane as well as parallel to the first connection plane.

This allows the connection element to easily and reliably balance thermally and mechanically caused stresses, whereby high mechanical stresses on the connections between the connection element and the electronic elements can be reduced or avoided. A particularly high longevity of the electrical connections can thus be enabled. Furthermore, there is a resulting advantage that a high degree of flexibility in the geometrical design of the connection element can be easily enabled. For example, through simple and inexpensive means, a geometry of the connection element can be adjusted for different geometrical properties of the electronic elements.

Preferably, the connection element is formed from an electrically conductive material, preferably copper or aluminum, or a copper alloy or an aluminum alloy.

Preferably, the second connection region lies in a second connection plane. The first connection plane and the second connection plane are located at a predetermined distance from one another. For example, the distance can be in the range of several millimeters in order to reliably ensure sufficient flexibility. This enables a high degree of flexibility and ease of manufacture in a particularly simple and cost-efficient manner.

Particularly preferably, the connection element further comprises a transition region connecting the first connection region and the second connection region to one another. The transition region lies in a transition plane, which is located at a distance from the first connection plane and the second connection plane. That is to say, the two connection regions and the transition region lie on a total of three different planes. In particular, a plurality of, preferably at least four, changes in direction of the sheet-like connection element between the first connection region and the second connection region are thus given. Thus, a particularly high mechanical flexibility can be provided in a simple manner.

Preferably, the first connection plane lies between the transition plane and the second connection plane. In particular, the two connection planes and the transition plane are located parallel to one another. Thus, for example, on a side of the two connection regions opposite the transition region, a particularly large amount of space can be provided for electronic components or the like.

Further preferably, the transition region, the first connection region, and the second connection region are formed together as an integral, preferably sheet-like, component. A particularly simple and cost-effective manufacturing can thus be enabled. In addition, a particularly reliable, high electrical conductivity of the connection element can be provided.

Preferably, at least one of the two connection regions comprises a slot. In particular, the slot fully penetrates at least a sub-region of the connection region, preferably in a direction that is orthogonal to the respective connection plane. As a result, an additional mechanical flexibility of the connection element is provided, in particular in a direction that is parallel to the first connecting plane. Thermally caused stresses in the connection element as well as in the region of the connection between the connection element and the electronic element can be avoided particularly effectively due to a slotted connection region.

Particularly preferably, the slot extends into the transition region. In other words, the connection element is completely separated by the slot into at least two separate sub-regions. A particularly effective and reliable reduction of stresses in the connection region can thus be achieved.

Preferably, the slot terminates in a relief recess. That is to say, the slot preferably extends from the relief recess to the edge of the sheet-like connection region. The relief recess has a minimum opening diameter that is larger than a width of the slot. Preferably, the relief recess has a circular cross-section, wherein a diameter is larger than the width of the slot, in particular. Preferably, the diameter is at least 1.5 times, preferably at least twice, the width of the slot. For example, due to the relief recess, enlarged radii can be provided at end regions of the slot, whereby mechanical stresses in that region can be easily and effectively reduced. Thus, a particularly robust and durable construction of the connection elements can be enabled.

Particularly preferably, the connection element comprises a plurality of slots in each of the connection regions. For example, the slots can extend parallel to one another and can preferably be located evenly spaced apart from one another. Particularly effective mechanical relief of the electrical connections can take place due to a plurality of slots.

Further preferably, the connection element comprises a plurality of first connection regions and/or a plurality of second connection regions. For example, a plurality of first electronic elements and/or a plurality of second electronic elements can thereby be connected to one another. Alternatively, for example, a single electronic element can also be electrically connected by means of a plurality of first or second connection regions.

Preferably, the plurality of connection regions are designed as separate components and are connected to one another by means of an electrically conductive connection. For example, the electrically conductive connection can be made by laser welding, soldering, or the like. For example, the plurality of connection elements can be connected to one another by means of a suitable connecting means, which can remain after assembly or can be removed. Thus, a particularly high flexibility of the connection element can be provided for different applications.

Particularly preferably, the electrically conductive connection of the connection regions designed as separate components is located, in particular exclusively, at the transition region. This allows for a particularly simple and inexpensive manufacture of the connection element, wherein an optimal mechanical flexibility can also be ensured.

Furthermore, the invention results in an electronic assembly comprising a first electronic element, a second electronic element, and a connection element as described above. The electronic elements can be, for example, electronic components or parts thereof. Preferably, the electronic elements can be electronically powered components. For example, the electronic elements can be located on a common printed circuit board and/or on separate printed circuit boards.

The invention further relates to an inverter comprising the above described electronic assembly.

### BRIEF DESCRIPTION OF THE DRAWINGS

The invention is described below based on exemplary embodiments in connection with the figures. In the figures, functionally identical components are respectively denoted by identical reference signs. Shown are:

FIG. 1 a simplified schematic view of an electronic assembly having a connection element according to a first exemplary embodiment of the invention,

FIG. 2 a side view of the electronic assembly of FIG. 1, and

FIG. 3 a simplified schematic view of a connection element according to a second exemplary embodiment of the invention.

### DETAILED DESCRIPTION

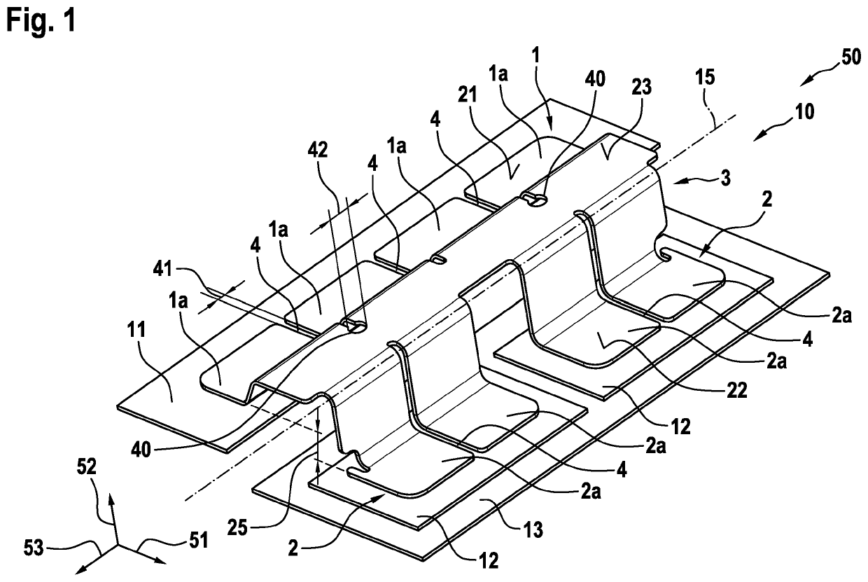

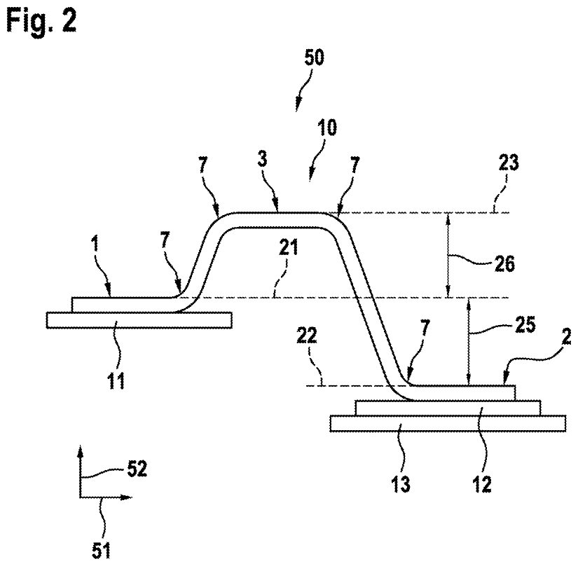

FIG. 1 shows a simplified schematic view of an electronic assembly 50 comprising a connection element 10 according to a first exemplary embodiment of the invention. For example, the electronic assembly 50 can be part of an inverter (not shown). The electronic assembly 50 is shown here in a perspective view. FIG. 2 shows the electronic assembly 50 of FIG. 1 in a side view.

The electronic assembly 50 comprises a plurality of electronic elements 11, 12, which can be, for example, electronic components. By way of example, the electronic assembly 50 of the first exemplary embodiment of FIG. 1 comprises exactly one first electronic element 11 and two second electronic elements 12. The second electronic elements 12 can be located on a common printed circuit board 13, as shown by way of example. Alternatively, any further assemblies with printed circuit boards or sub-regions of printed circuit boards can also be provided as electronic elements 11, 12.

In the illustrated exemplary embodiment, the connection element 10 is provided in order to electrically connect all electronic elements 11, 12 to one another. For this purpose, the connection element 10 is designed as a sheet of an electrically conductive material, for example copper.

The connection element 50 comprises a plurality of connection regions 1, 2 which are connected in a directly electrically conductive manner to one of the electronic elements 11, 12. This electrically conductive connection can be made by means of, for example, a laser weld joint or a solder joint, or the like.

In order to provide a high resistance to thermomechanical stresses and thus a high longevity, the connection element 10 has a special construction, which is described in detail below.

The first connection region 1 of the connection element 10 is connected in an electrically conductive manner to the first electronic element 11 and lies in a first connection plane 21. The two second connection regions 2 of the connection element 10 are connected in an electrically conductive manner to one of the two second electronic elements 12, respectively, and lie in a common second connection plane 22.

In addition, the connection element 10 comprises a transition region 3 connecting the first connection region 1 and the second connection regions 2 to one another. The transition region 3, the first connection region 1, and the second connection regions 2 are formed together as an integral component. Angled regions of the connection element 10 can be provided between the transition region 3 and the respective connection regions 1, 2.

The connection element 10 is designed as a curved sheet, such that the first connection region 1, the second connection regions 2, and the transition region 3 each lie on different planes 21, 22, 23 (cf. in particular FIG. 2). In particular, the respective planes 21, 22, 23 are parallel to one another. In detail, the first connection plane 21, which is defined by a top side of the first connection region 1, is located at a predetermined first distance 25 from a second connection plane 22, which defined by a top side of the second connection region 2. In addition, the first connection plane 21 is located at a predetermined second distance 26 from a transition plane 23, which is defined by a top of the transition region 3.

The first connection region 1 lies along a direction that is orthogonal to the planes 21, 22, 23 between the transition region 3 and the second connection regions 2. That is to say, the connection element 10 has a stepped geometry with the connection regions 1, 2 that lie on different planes 21, 22. The transition region 3 is also provided, which likewise lies on a further additional plane 23.

This specific geometry is achieved in that the connection element 10 comprises a plurality of bending points 7 (cf. FIG. 2). On the bending points 7, the connection element 10 is bent respectively around a bending axis, which lies in the respective adjacent plane 21, 22, 23, and which is parallel to a major axis 15 along which the entire connection element 10 extends (cf. FIG. 1).

This results in the advantage of a particularly high mechanical flexibility of the connection element 10. With the bending and the arrangement of the connection regions 1, 2 on different planes 21, 22, 23, a particularly high flexibility in the directions 51 and 52 marked in FIGS. 1 and 2 is provided. For example, the connection element 10 can deform slightly elastically in order to compensate for thermal and mechanical stresses that can occur, for example due to operation or due to ambient conditions of the electronic assembly 50. As a result, the electrical connections between the connection region 1, 2 and the electronic elements 11, 12 is relieved, in particular, so that the former can achieve a particularly reliable, long service life.

A further additional relief of the electrical connection points is achieved by a slotting of the connection regions 1, 2. Each connection region 1, 2 comprises at least one slot 4, which extends completely through the respective connection region 1, 2. In detail, each slot 4 extends orthogonally to the main axis 15 from an outer edge of the respective connection region 1, 2 up to the transition region 3. As a result, each connection region 1, 2 is divided into a plurality of connection tabs 1a, 2a.

In detail, in the first exemplary embodiment shown, the first connection region 1 is divided into a total of four first connection tabs 1a by a total of three slots 4. Each second connection region 2 is also divided into two connection tabs 2a by exactly one slot 4 each. Each connection tab 1a, 2a is separately connected to the corresponding electronic element 11, 12 in an electrically conductive manner.

With the slots 4, an additional mechanical relief in a further direction, shown in FIG. 1 by the direction 53, which is parallel to the main axis 15, can thus be achieved.

In addition, it is provided that at least some of the slots 4 terminate in a relief recess 40, as shown in FIG. 1, which has a circular opening diameter 42 that is greater than a width 41 of the slot 4. As a result, an enlarged radius can be provided at the end region of the slot 4, whereby mechanical stresses in this region can be reduced.

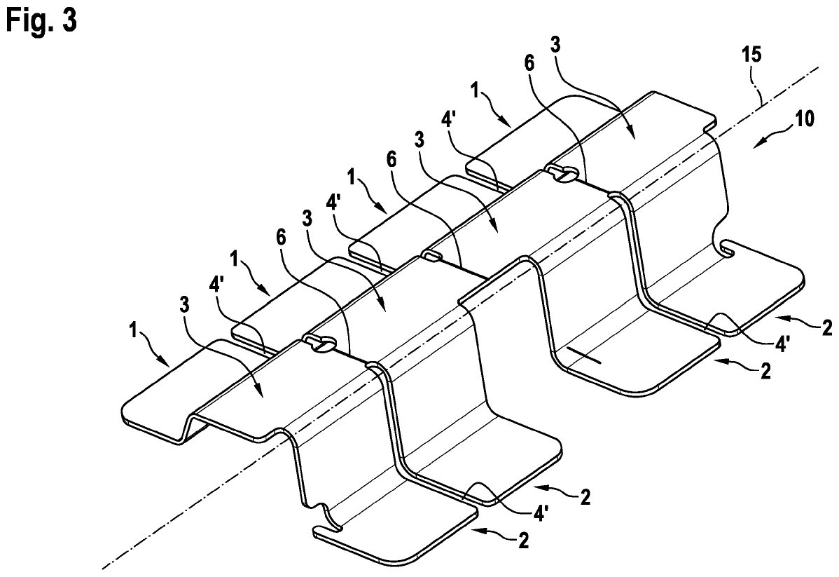

FIG. 3 shows a simplified schematic view of a connection element 10 according to a second exemplary embodiment of the invention. The second exemplary embodiment corresponds substantially to the first exemplary embodiment of FIGS. 1 and 2, with the difference that the connection element 10 is made up of multiple parts. In detail, the connection element 10 comprises a plurality of connection regions 1, 2, wherein the plurality of connection regions 1, 2 are each designed as separate components. In detail, exactly one first connection region 1 and exactly one second connection region 2 are each designed as a common integral component. These individual components are connected to one another by means of an electrically conductive connection 6.

The individual parts of the connection element 10 of the second exemplary embodiment can be connected to one another, for example, such that between the individual connection regions 1, 2, respectively, there are gaps 4′, which can substantially correspond to the slots 4 of the first exemplary embodiment of FIGS. 1 and 2. The electrically conductive connections 6 can be located, preferably exclusively, in the transition region 3 and can lie substantially in an extension of the gaps 4′.

1. A connection element for electrically connecting electronic elements (11, 12), comprising:
a first connection region (1) configured for connection to a first electronic element (11), and
a second connection region (2) configured for connection to a second electronic element (12),
wherein each connection region (1, 2) is in the form of a sheet,
wherein the first connection region (1) is in a first connection plane (21), and
wherein the second connection region (2) is located at a distance from the first connection plane (21).

2. The connection element according to claim 1, wherein the second connection region (2) is in a second connection plane (22), and wherein the first connection plane (21) and the second connection plane (22) are located parallel to one another and at a predetermined distance (25) from one another.

3. The connection element according to claim 2, further comprising a transition region (3) connecting the first connection region (1) and the second connection region (2) to one another, wherein the transition region (3) lies in a transition plane (23) that is located at a distance from the first connection plane (21) and the second connection plane (22).

4. The connection element according to claim 3, wherein the first connection plane (21) lies between the transition plane (23) and the second connection plane (22).

5. The connection element according to claim 3, wherein the transition region (23), the first connection region (1) and the second connection region (2) are formed together as an integral component.

6. The connection element according to claim 3, wherein at least one of the connection regions (1, 2) comprises a slot (4).

7. The connection element according to claim 6, wherein the slot (4) extends into the transition region (3).

8. The connection element according to claim 6, wherein the slot (4) terminates in a relief recess (40), wherein the relief recess (40) has a minimum opening diameter (42) that is greater than a width (41) of the slot (4).

9. The connection element according to claim 6, comprising a plurality of slots (4) in each of the connection regions (1, 2).

10. The connection element according to claim 1, comprising a plurality of first connection regions (1) and/or a plurality of second connection regions (2).

11. The connection element according to claim 10, wherein the plurality of connection regions (1, 2) are configured as separate components and are connected to one another by an electrically conductive connection (6).

12. The connection element according to claim 11, wherein the electrically conductive connection (6) is located at a transition region (3) connecting the first connection region (1) and the second connection region (2) to one another.

13. An electronic assembly comprising a first electronic element (11), a second electronic element (12), and a connection element (10) according to claim 1.

14. An inverter comprising an electronic assembly (50) according to claim 13.

15. The connection element according to claim 12, wherein the electrically conductive connection (6) is located exclusively at the transition region (3).
